(19) United States
(12) Patent Application Publication
(10) Pub. No.: US 2007/0177815 A1
(43) Pub. Date: Aug. 2, 2007

(54) Method, video display system and automobile video display system

(75) Inventors: Sun-Chen Yang, Taipei City (TW); Han-Hsun Chen, Taipei City (TW); Hsiang-Jui Hung, Taipei City (TW); Chun-San Lin, Taipei City (TW); Yun-Jiun You, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/698,115

(22) Filed: Jan. 26, 2007

(30) Foreign Application Priority Data
Jan. 27, 2006 (TW) 095103545

(51) Int. Cl. G06K 9/40

(52) U.S. Cl. 382/254

(57) ABSTRACT

A method for displaying a video image includes: receiving the video image and performing a real-time detection upon the video image to detect at least a contour section in the video image; determining a compensation characteristic according to the contour section; adjusting pixel values of pixels corresponding to the contour section according to the compensation characteristic; and displaying the adjusted video image.

### BACKGROUND OF THE INVENTION

1. Field of the Invention

This invention relates to a video adjusting method and apparatus thereof, and more particularly, to a method and apparatus for detecting the contour section of the real-time video image and compensating for the contour section to improve the display quality.

2. Description of the Prior Art

Real-time video systems are often utilized for providing video information simultaneously when applied in a real-time video surveillance system. For example, in order to ensure that car drivers can clearly see images of what is behind their car, the real-time video system (e.g., a CCD camera) can be positioned in the rear portion of the car to provide the needed real-time information. In general, the conventional real-time video system may perform the image adjusting process, such as screen brightness or color temperature adjusting, between the camera instrument and the display monitor to make sure the image is clear for displaying on the monitor. However, the environment being monitored by the real-time video surveillance system can easily change quickly. Specifically, the amount of light (e.g., ambient light) available in the environment for lighting of the images caught by the camera sometimes changes very quickly. For example, when the driver operates the car in a reverse direction has and at the same time, a series of other cars pass by, the lights (e.g., headlights) of the other passing cars may directly reflect into the camera instrument. This event will cause image distortion since the conventional video system cannot process the series of images having such a massive variation of light. Moreover, the conventional video system cannot strengthen the specific subject (e.g., an object residing behind said car) in a darkened environment. Therefore, the driver cannot differentiate certain specific subjects (e.g., a child or an animal) and this may lead to an accident. Furthermore, if the processing speed of the conventional video system is slower than speed at which the lighting aspect of the environment is changing, then the conventional video system may collect incorrect or abnormal video information. In addition, when the driver of the car wishes to turn the car right or left, the driver of the car will always utilize the right and left side rear view mirrors for determining whether other cars are coming from the rear. However, the right or left rear view mirrors each have what is commonly referred to as a blind spot. As is well know, the blind spot of said mirrors cannot provide sufficient information (i.e., images) to the driver. Therefore, accidents may result from the situation of having insufficient information.

### SUMMARY OF THE INVENTION

It is therefore one of the many objectives of the claimed invention to provide a method for detecting a contour section in a video image and determine a compensation characteristic according to the contour section, a video display system, and a automobile video display system, to solve the above-mentioned problems.

According to an aspect of the present invention, a method for displaying a video image is disclosed. The method for displaying a video image includes: detecting at least a contour section in the video image; determining a compensation characteristic according to the contour section; adjusting pixel values of pixels corresponding to the contour section according to the compensation characteristic; and displaying the adjusted video image.

According to another aspect of the present invention, a video display system is disclosed. The video display system includes: a detecting module for detecting a video image, and detecting at least a contour section in the video image; a determining unit, coupled to the detecting unit, for determining a compensation characteristic according to the contour section; a compensating unit, coupled to the determining unit, for adjusting pixel values of pixels corresponding to the contour section according to the compensation characteristic; and a display monitor, coupled to the compensation unit, for displaying the adjusted video image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a video processing unit according to an embodiment of the present invention.

FIG. 2 is a schematic diagram illustrating the video processing unit shown in FIG. 1 performing a soften process.

FIG. 3 is a schematic diagram illustrating the video processing unit shown in FIG. 1 performing a sharpen process.

FIG. 4 shows a flowchart illustrating an embodiment of the operation of displaying a video image.

FIG. 5 is a block diagram of the automobile real-time video display system according to an embodiment of the present invention.

FIG. 6 is a schematic diagram illustrating setup locations of recording devices of the automobile real-time video display system shown in FIG. 5.

FIG. 7 shows a flowchart illustrating another embodiment of the operation of displaying a video image.

### DETAILED DESCRIPTION

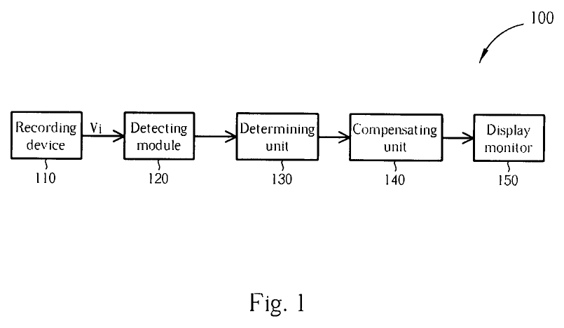

Please refer to FIG. 1. FIG. 1 is a block diagram of the video processing unit 100 according to an embodiment of the present invention. As shown in FIG. 1, the video processing unit 100 includes a recording device 110 (e.g., a CCD camera), a detecting module 120, a determining unit 130, a compensating unit 140, and a display monitor 150. The recording device 110 provides a video signal Vi according to the recordable range. The video signal Vi, after being provided by the recording device 110, is sent into the detecting module 120. The detecting module 120 then detects the contour section of the video signal Vi. In general, the contour section of a video image can be determined by a variety of prior art methods. For example, the contour section of a video image can be determined by the difference of the gray level values of two adjacent pixels. Since the method of determining the contour section is considered well-known to those having average skill in the pertinent art, further details are hereinafter omitted for the sake of brevity.

Next, the determining unit 130 determines a compensation characteristic according to the contour section detected by the detecting module 120. In this prefer embodiment, if the gray level values of two adjacent pixels in a contour section are greater than a predetermined threshold value, then the difference of the pixel value of the video signal Vi is deemed to be too large wherein it could cause the video image to become obscured or overly harsh to the viewer's eye. In this case, the determining unit 130 determines the contour section detected by the detecting module 120 needs to be softened. In the other hand, if the gray level values of two adjacent pixels in a contour section are less than a predetermined threshold value, that means the difference of the pixel value of the video signal Vi is too small (e.g., a dark environment exists at the moment) so that the video seems obscure. In this case, the determining unit 130 then determines the contour section detected by the detecting module 120 needs to be sharpened.

Next, the compensating unit 140 provides a compensation value according to the compensation characteristic determined by the determining unit 130 to the pixel corresponding to the contour section for further adjusting the gray level value of the pixel. If the compensation characteristic of the determining unit 130 is determined to be softened, that means the difference of the gray level value of the adjacent pixel in the original contour section is too large, the compensating unit 140 thus reduces the graylevel value of the pixel whose gray level value is originally larger, and increases the gray level value of the pixel whose gray level value is originally smaller to soften the original contour section. Similarly, if the compensation characteristic of the determining unit 130 is determined to be sharpened, that means the difference of the gray level value of the adjacent pixel in the original contour section is too small, the compensating unit 140 thus increases the gray level value of the pixel whose gray level value is originally larger, and reduces the gray level value of the pixel whose gray level value is originally smaller to strengthen the original contour section. Finally, the display monitor 150 then displays the video signal Vi adjusted by the compensating unit 140.

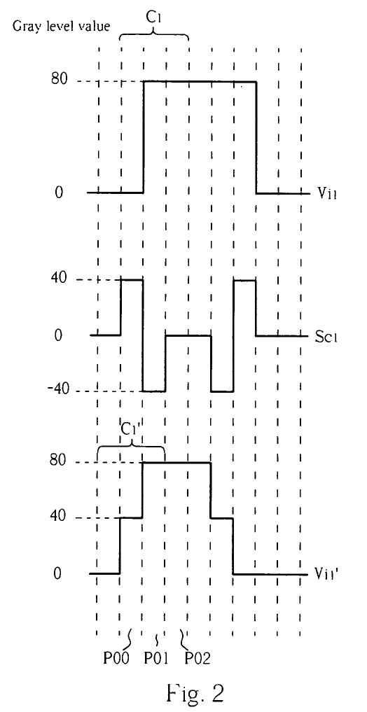

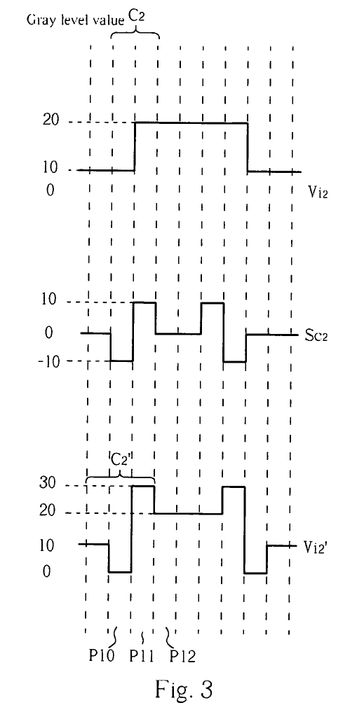

For illustrating this embodiment in more detail, please refer to FIG. 2 and FIG. 3. FIG. 2 is a schematic diagram illustrating the video processing unit 100 shown in FIG. 1 performing the softening process. Additionally, FIG. 3 is a schematic diagram illustrating the video processing unit 100 shown in FIG. 1 performing the sharpening process. As shown in FIG. 2, assuming that in a specific situation (e.g., a strong/bright light situation), the gray level values of the adjacent pixels P₀₀ and P₀₁ in a contour section C₁ of the video signal Vi₁ is respectively 0 and 80. And a predetermined highest threshold value is set to be 70. Then the determining unit 130 determines the contour section C₁ needs to be softened according that the difference of the gray level values of the pixels P₀₀ and P₀₁ (80−0=80) is greater than the highest threshold value 70. Next, the compensating unit 140 provides a soften compensation signal Sc₁ according to the determining unit 130. As shown in FIG. 2, the soften compensation signal Sc₁ provides a +40 compensation value on the pixel P₀₀ and provides a −40 compensation value on the pixel P₀₁ so that reduces the larger gray level value of the pixel P₀₁ and increases the smaller gray level value of the pixel P₀₀ to achieve the softening process. As shown in FIG. 2, finally, the video signal Vi₁′ which has been adjusted by the compensating unit 140 then can generate a softened contour section C₁′, and therefore can reduce the harshness from the video image to the eye caused by, for example, the strong flashlight effect of passing car lights.

Similarly, as shown in FIG. 3, assuming that in a specific situation (e.g., a dark environment), the gray level values of the adjacent pixels P₀₀ and P₀₁ in a contour section C₁ of the video signal Vi₁ are respectively 10 and 20. Assume also that a predetermined lowest threshold value is set to 15. Now, the determining unit 130 determines that the contour section C₁ needs to be sharpened according that the difference of the gray level values of the pixels P₀₀ and P₀₁ (20−10=10) is less than the highest threshold value 15. Next, the compensating unit 140 provides a sharpening compensation signal Sc₂ according to decision of the determining unit 130. As shown in FIG. 3, the softening compensation signal Sc₂ provides a −10 compensation value on the pixel P₁₀ and provides a +10 compensation value on the pixel P₁₁ and thereby increases the larger gray level value of the pixel P₁₁ and reduces the smaller gray level value of the pixel P₁₀ to achieve the sharpening process. As shown in FIG. 3, finally, the video signal Vi₂′ which has been adjusted by the compensating unit 140 then can generate a sharpened contour section C₂′, and therefore the driver (i.e., the viewer of the video image) can recognize the specific subject matter in the dark environment, for example, a child, person, or animal.

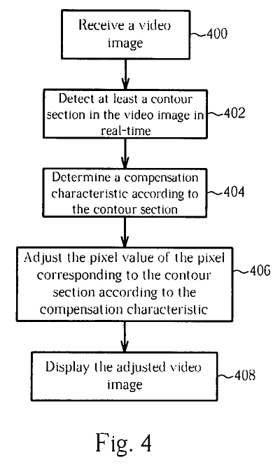

Please refer to FIG. 4. FIG. 4 shows a flowchart illustrating an embodiment of the operation of displaying a video image. In this embodiment, the method of displaying the video image can be embodied by the video processing unit 100 as shown in FIG. 1. The method is detailed as follows:
Step 400: Receive a video image.
Step 402: Detect at least a contour section in the video image in real-time.
Step 404: Determine a compensation characteristic according to the contour section.
Step 406: Adjust the pixel value of the pixel corresponding to the contour section according to the compensation characteristic.
Step 408: Display the adjusted video image.

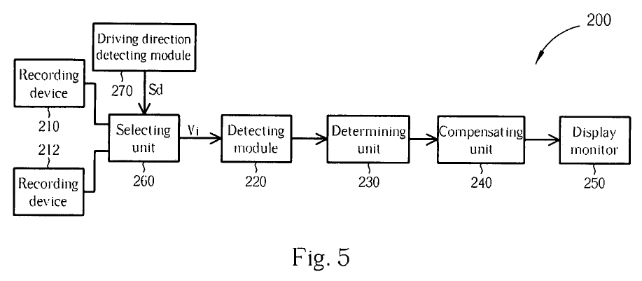

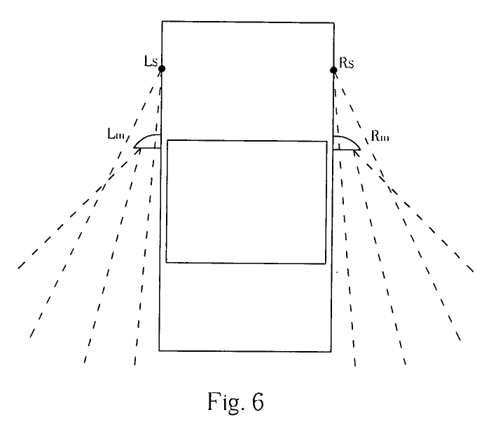

Additionally, the embodiment of the present invention can provide a plurality of recording devices and the plurality of recording devices can be set/positioned at the two sides of the car to reduce the blind spot experienced by the drivers of the car. Please refer to FIG. 5 and FIG. 6. FIG. 5 is a block diagram of the automobile real-time video display system 200 according to an embodiment of the present invention. And FIG. 6 is a schematic diagram illustrating the setup locations of the recording device 210, 212 of the automobile real-time video display system 200 shown in FIG. 5. Since elements having the same name in FIG. 5 and FIG. 1 have the same function and operation, the detailed description is hereinafter omitted for the sake of brevity. The primary difference between the elements in FIG. 5 and those corresponding said elements in FIG. 1 is that the automobile real-time video display system 200 adds a plurality of recording device 210, 212, a selecting unit 260, and a driving direction detecting module 270. The selecting unit 260 selects a recording device from a plurality of recording device 210, and 212 to be a receiving source to receive the video image according to a detecting signal S_{d} corresponding to a change in the driving direction. Please note that, the present invention does not limit the generating mechanism of the detecting signal S_{d}. For example, the driving direction detecting module 270 may trigger the detecting signal S_{d} according to the motion of driver controlling the car (e.g., turn right or turn left motion). Therefore, the selecting unit 260 then recognizes the change of the driving direction according to the received detecting signal S_{d}, and selects the required recording device from the recording device 210 or 212. In this embodiment, the recording device 210 and 212 can be set respectively in the position Ls and Rs shown in FIG. 6. As shown in FIG. 6, the right rear view mirror Rm or the left rear view mirror Lm shown in FIG. 6 each has blind spots. And when the environment's light level is too strong or too weak, the right rear view mirror Rim or the left rear view mirror Lm cannot provide the needed compensation effect of the video display system. Therefore, the automobile real-time video display system 200 in the embodiment of the present invention provides a plurality of recording device 210 and 212 set at both of the two sides of the car so as to provide a boarder viewing space to reduce the blind spots. In conjunction with the above-mentioned video compensation method, the automobile real-time video display system 200 in the present invention can provide full and necessary driving information to the driver of the car.

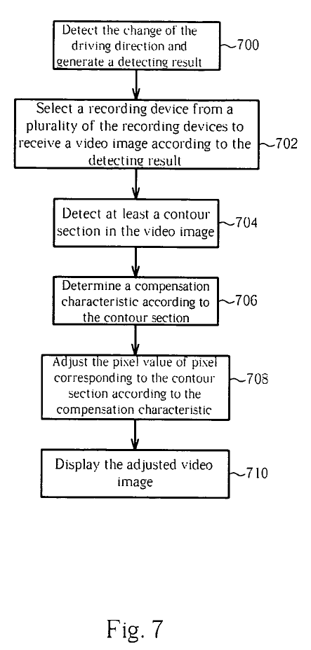

Please refer to FIG. 7. FIG. 7 shows a flowchart illustrating another embodiment of the operation of displaying a video image. In this embodiment, the method of displaying a video image can be embodied by the video processing unit 200 shown in FIG. 5. The method is detailed as follows:
Step 700: Detect a change in a driving direction and generate a detecting result.
Step 702: Select a recording device from a plurality of recording devices to receive a video image according to the detecting result.
Step 704: Detect at least a contour section in the video image. Step 706: Determine a compensation characteristic according to the contour section.
Step 708: Adjust a pixel value of a pixel corresponding to the contour section according to the compensation characteristic.
Step 710: Display the adjusted video image.

In contrast to the related art, the video processing unit of the embodiment of the present invention and the related video display method can detect and adjust the contour of the video according to the video compensation so that significant and necessary improvement in the quality of the video image is achieved and thereby visual related errors by the driver of the car are reduced. The video processing unit of the embodiment of the present invention and the related video display method also provide a plurality of recording device set at both of the two sides of the car to reduce the driver's blind spot and greatly improve driving safety.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying a video image, comprising:
detecting at least a contour section in the video image;
determining a compensation characteristic according to the contour section;
adjusting pixel values of pixels corresponding to the contour section according to the compensation characteristic; and
displaying the adjusted video image.

2. The method of claim 1, wherein the contour section comprises at least a first pixel and at least a second pixel, and the step of determining the compensation characteristic comprises:
if the difference between the pixel values of the first, second pixels is greater than a first threshold value, the compensation characteristic determines to perform a softening process to the contour section; and
if the difference between the pixel values of the first, second pixels is less than a second threshold value, the compensation characteristic determines to perform a sharpening process to the contour section.

3. The method of claim 2, wherein the step of adjusting pixel values of pixels corresponding to the contour section comprises:
if the compensation characteristic determines to perform the softening process to the contour section and the pixel value of the first pixel is greater than the pixel value of the second pixel, reduce the pixel value of the first pixel and increase the pixel value of the second pixel.

4. The method of claim 2, wherein the step of adjusting pixel values of pixels corresponding to the contour section comprises:
if the compensation characteristic determines to perform the sharpening process to the contour section and the pixel value of the first pixel is greater than the pixel value of the second pixel, increase the pixel value of the first pixel and reduce the pixel value of the second pixel.

5. A method for displaying a video image, comprising:
providing a display monitor and a plurality of recording devices;
detecting a change in the driving direction, and selecting a specific recording device from the recording devices according to a detecting result; and
displaying the video image generated by the specific recording device by utilized the display monitor.

6. The method of claim 5, wherein the step of displaying the video image generated by the specific recording device by utilized the display monitor comprises:
detecting at least a contour section in the video image;
determining a compensation characteristic according to the contour section;
adjusting pixel values of pixels corresponding to the contour section according to the compensation characteristic; and
displaying the adjusted video image.

7. The method of claim 6, wherein the contour section comprises at least a first pixel and at least a second pixel, and the step of determining the compensation characteristic comprises:
if the difference between the pixel values of the first, second pixels is greater than a first threshold value, the compensation characteristic determines to perform the softening process to the contour section; and
if the difference between the pixel values of the first, second pixels is less than a second threshold value, the compensation characteristic determines to perform the sharpening process to the contour section.

8. The method of claim 7, wherein the step of adjusting pixel values of pixels corresponding to the contour section comprises:
if the compensation characteristic is determined to perform the softening process to the contour section and the pixel value of the first pixel is greater than the pixel value of the second pixel, reduce the pixel value of the first pixel and increase the pixel value of the second pixel.

9. The method of claim 7, wherein the step of adjusting pixel values of pixels corresponding to the contour section comprises:
if the compensation characteristic is determined to perform the sharpening process to the contour section and the pixel value of the first pixel is greater than the pixel value of the second pixel, increase the pixel value of the first pixel and reduce the pixel value of the second pixel.

10. A video display system, comprising:
a detecting module for detecting a video image, and detecting at least a contour section in the video image;
a determining unit, coupled to the detecting unit, for determining a compensation characteristic according to the contour section;
a compensating unit, coupled to the determining unit, for adjusting pixel values of pixels corresponding to the contour section according to the compensation characteristic; and
a display monitor, coupled to the compensation unit, for displaying the adjusted video image.

11. The video display system of claim 10, wherein the contour section comprises at least a first pixel and at least a second pixel, if the difference between the pixel values of the first, second pixels is greater than a first threshold value, the compensation characteristic determines to perform the softening process to the contour section; and
if the difference between the pixel values of the first, second pixels is less than a second threshold value, the compensation characteristic determines to perform the sharpening process to the contour section.

12. The video display system of claim 1 1, wherein if the compensation characteristic determines to perform the softening process to the contour section and the pixel value of the first pixel is greater than the pixel value of the second pixel, reduce the pixel value of the first pixel and increase the pixel value of the second pixel.

13. The video display system of claim 1 1, wherein if the compensation characteristic determines to perform the sharpening process to the contour section and the pixel value of the first pixel is greater than the pixel value of the second pixel, increase the pixel value of the first pixel and reduce the pixel value of the second pixel.

14. The video display system of claim 10, wherein the video display system comprises:
a plurality of recording device;
a driving direction detecting module for detecting a change of the driving direction and generating a detecting result; and
a selecting unit, coupled to the recording devices and the driving direction detecting module, for selecting a specific recording device from the recording devices to generate the video image according to the detecting result.

15. A automobile real-time video display system, comprising:
a plurality of recording device;
a driving direction detecting module for detecting a change in the driving direction and generating a detecting result;
a select unit, coupled to the recording devices and the driving direction detecting module, for selecting a specific recording device from the recording devices to generate the video image according to the detecting result; and
a display monitor for displaying the video image generated from the specific recording device.

16. The automobile real-time video display system of claim 15, further comprising:
a detecting module, coupled to the selecting unit, for receiving a video image, and detecting at least a contour section in the video image;
a determining unit, coupled to the detecting unit, for determining a compensation characteristic according to the contour section; and
a compensating unit, coupled to the determining unit, for adjusting pixel values of pixels corresponding to the contour section according to the compensation characteristic;
wherein the display monitor, coupled to the compensation unit, for displaying the adjusted video image.

17. The automobile real-time video display system of claim 15, wherein the contour section comprises at least a first pixel and at least a second pixel, if the difference between the pixel values of the first, second pixels is greater than a first threshold value, the compensation characteristic determines to perform the softening process to the contour section; and
if the difference between the pixel values of the first, second pixels is less than a second threshold value, the compensation characteristic determines to perform the sharpening process to the contour section.

18. The automobile real-time video display system of claim 15, wherein if the compensation characteristic determines to perform the softening process to the contour section and the pixel value of the first pixel is greater than the pixel value of the second pixel, reduce the pixel value of the first pixel and increase the pixel value of the second pixel.

19. The automobile real-time video display system of claim 15, wherein if the compensation characteristic determines to perform the sharpening process to the contour section and the pixel value of the first pixel is greater than the pixel value of the second pixel, increase the pixel value of the first pixel and reduce the pixel value of the second pixel.
